(19) United States
(12) Patent Application Publication
(10) Pub. No.: US 2025/0226940 A1
(43) Pub. Date: Jul. 10, 2025

(54) PHYSICAL RESOURCE ALLOCATION FOR MOBILE WI-FI STATIONS

(71) Applicant: GM Global Technology Operations LLC, Detroit, MI (US)

(72) Inventor: Azin Neishaboori, Plymouth, MI (US)

(73) Assignee: GM Global Technology Operations LLC, Detroit, MI (US)

(21) Appl. No.: 18/409,237

(22) Filed: Jan. 10, 2024

(51) Int. Cl. H04L 5/00; H04W 72/543

(52) U.S. Cl. CPC H04L 5/0048; H04L 5/0046; H04W 72/23; H04W 72/543

(57) ABSTRACT

A method for physical resource allocation for mobile Wi-Fi stations includes receiving, at an access point, a request for resources for a station, and determining that the station includes a mobile station, the mobile station moving relative to the access point at a speed exceeding a threshold speed. The method also includes processing the request for resources to determine that the request for resources includes a request for one of a trigger-based uplink or a downlink between the mobile station and the access point, and allocating one or more ultra-robust resource units to the mobile station. Here, each of the one or more ultra-robust resource units has a higher number of pilot tones than a standard resource unit of the same size.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to physical resource allocation for mobile Wireless Fidelity (Wi-Fi) stations. In particular, the present disclosure relates to utilizing Wi-Fi for mobile station connectivity.

Traditionally, mobile station (e.g., vehicles and/or mobile devices with Wi-Fi capability located within a car, bus, or train) connectivity relies on cellular networks. However, not only are the number of connected vehicles on the road increasing, but the number of applications within a particular vehicle that require internet connectivity is increasing rapidly. Relying solely on cellular networks to service these connectivity needs is not only expensive, but presses the processing limits of current cellular networks. While Wi-Fi networks are relatively inexpensive, the mobility of a vehicle introduces challenges including Doppler effect that degrades the network connection.

### SUMMARY

One aspect of the disclosure provides a computer-implemented method for physical resource allocation for mobile Wi-Fi stations that when executed on data processing hardware causes the data processing hardware to perform operations that include receiving, at an access point, a request for resources for a station, and determining that the station includes a mobile station. Here, the mobile station is moving relative to the access point at a speed exceeding a threshold speed. The operations also include processing the request for resources for the station to determine that the request for resources includes a request for one of a trigger-based uplink or a downlink between the mobile station and the access point, and allocating one or more ultra-robust resource units to the mobile station. Here, each of the one or more ultra-robust resource units has a higher number of pilot tones than a standard resource unit of the same size.

Implementations of the disclosure may include one or more of the following optional features. In some implementations, the one or more ultra-robust resource units includes a distributed resource unit. In some examples, the number of pilot tones of each of the one or more ultra-robust resource units is selectable from a finite pre-defined set. In these examples, the operations may further include selecting the number of pilot tones of each of the ultra-robust resource units based on the speed of the mobile station. In some implementations, each of the one or more ultra-robust resource units includes a selectable inter-subcarrier spacing from a finite pre-defined set. In these implementations, the operations may further include selecting the inter-subcarrier spacing of each of the ultra-robust resource units based on the speed of the mobile station.

In some examples, allocating the one or more ultra-robust resource units to the mobile station includes allocating the number of the one or more ultra-robust resource units based on the speed of the mobile station. In some implementations, the request for resources includes one of an instantaneous speed of the station or an identifier of the station. Here, determining that the station includes the mobile station is based on the one of the instantaneous speed of the station or the identifier of the station. In some examples, allocating the one or more ultra-robust resource units includes determining a concurrent and interfering connection operating in a band and frequency channels of a first size, and selecting an inter-subcarrier spacing of each of the one or more ultra-robust resource units having a second size greater than the first size. In some implementations, the mobile station is a vehicle.

Another aspect of the disclosure provides a system for physical resource allocation for mobile Wi-Fi stations that includes data processing hardware and memory hardware in communication with the data processing hardware. The memory hardware stores instructions that when executed by the data processing hardware cause the data processing hardware to perform operations that include receiving, at an access point, a request for resources for a station, and determining that the station includes a mobile station. Here, the mobile station is moving relative to the access point at a speed exceeding a threshold speed. The operations also include processing the request for resources for the station to determine that the request for resources includes a request for one of a trigger-based uplink or a downlink between the mobile station and the access point, and allocating one or more ultra-robust resource units to the mobile station. Here, each of the one or more ultra-robust resource units has a higher number of pilot tones than a standard resource unit of the same size.

This aspect may include one or more of the following optional features. In some implementations, the one or more ultra-robust resource units includes a distributed resource unit. In some examples, the number of pilot tones of each of the one or more ultra-robust resource units is selectable from a finite pre-defined set. In these examples, the operations may further include selecting the number of pilot tones of each of the ultra-robust resource units based on the speed of the mobile station. In some implementations, each of the one or more ultra-robust resource units includes a selectable inter-subcarrier spacing from a finite pre-defined set. In these implementations, the operations may further include selecting the inter-subcarrier spacing of each of the ultra-robust resource units based on the speed of the mobile station.

In some examples, allocating the one or more ultra-robust resource units to the mobile station includes allocating the number of the one or more ultra-robust resource units based on the speed of the mobile station. In some implementations, the request for resources includes one of an instantaneous speed of the station or an identifier of the station. Here, determining that the station includes the mobile station is based on the one of the instantaneous speed of the station or the identifier of the station. In some examples, allocating the one or more ultra-robust resource units includes determining a concurrent and interfering connection operating in a band and frequency channels of a first size, and selecting an inter-subcarrier spacing of each of the one or more ultra-robust resource units having a second size greater than the first size. In some implementations, the mobile station is a vehicle.

### BRIEF DESCRIPTION OF THE DRAWINGS

The drawings described herein are for illustrative purposes only of selected configurations and are not intended to limit the scope of the present disclosure.

FIG. 1 is a schematic view of an example system for physical resource allocation for mobile Wi-Fi stations.

FIG. 2 is a schematic view of example components of the system of FIG. 1.

FIGS. 3A-3C are schematic views of resource units of the system of FIG. 1.

FIG. 4 is a flowchart of an example arrangement of operations for a method of physical resource allocation for mobile Wi-Fi stations.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art.

Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

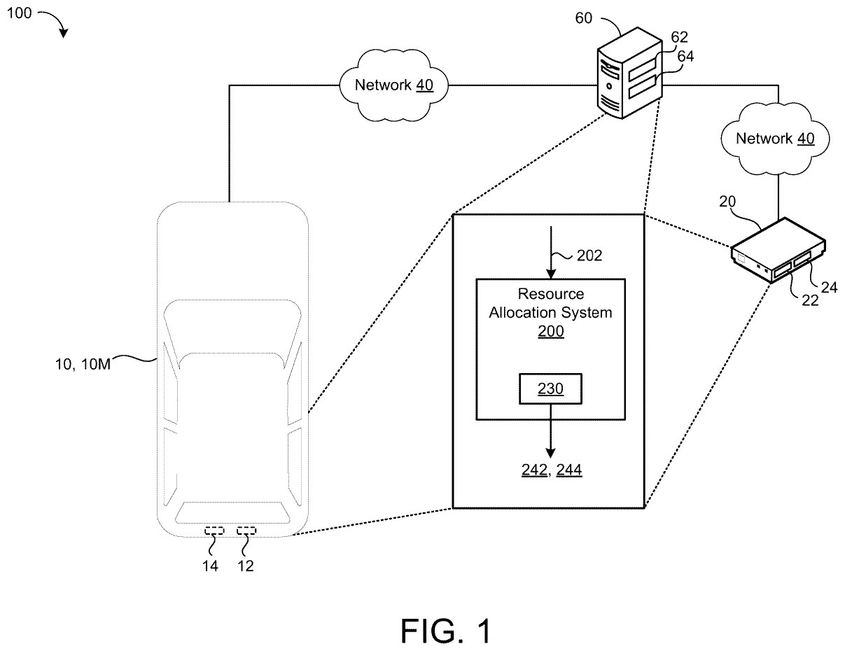

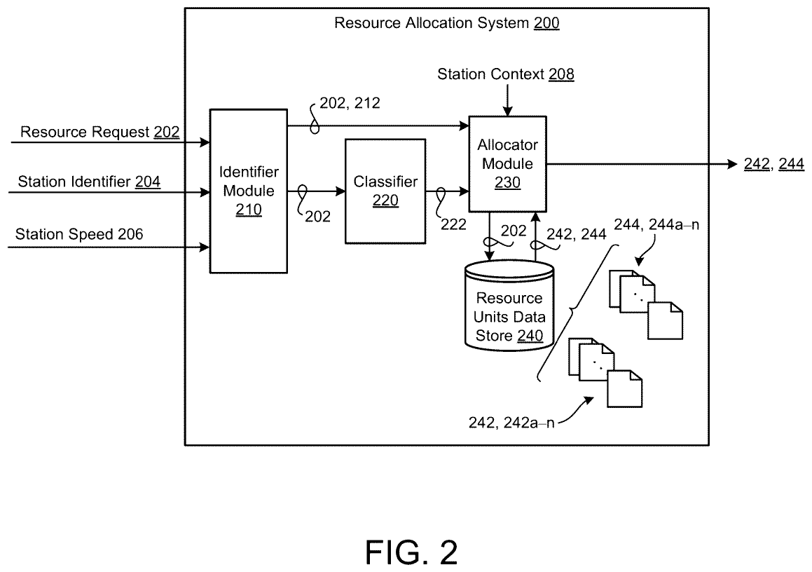

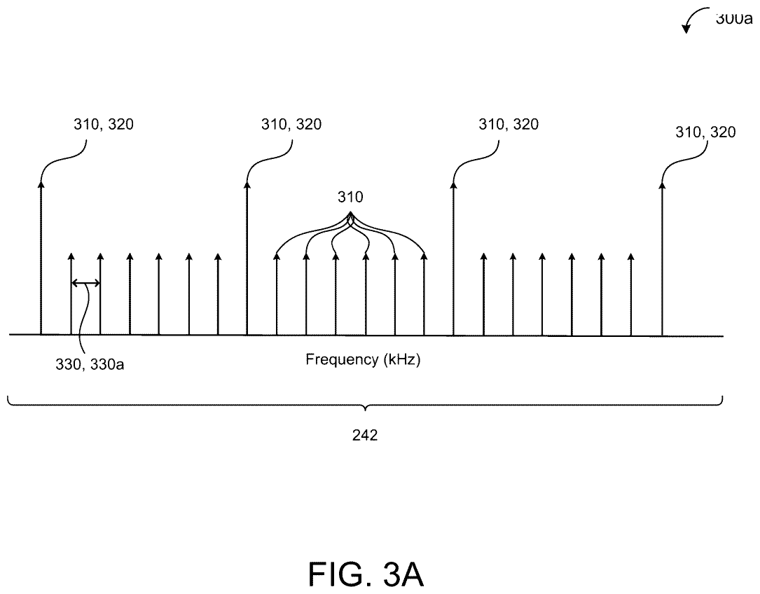

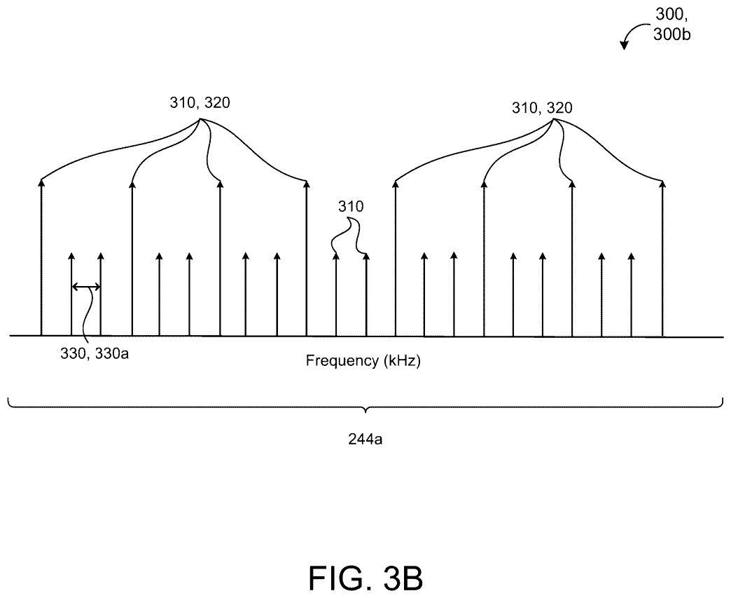

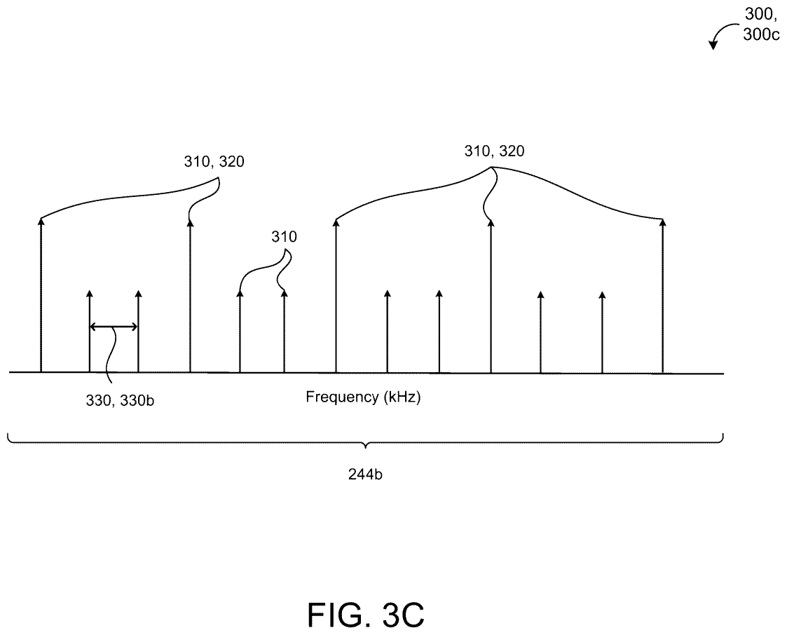

FIG. 1 illustrates an example system 100 including a station 10 (also referred to as a mobile station 10M), an access point 20, and/or a remote system 60 in communication with the station 10 and the access point 20 via a network 40. The system 100 includes a resource allocation system 200 that allocates resource units 242, 244 for transmitting data between the station 10 and the access point 20, where the resource allocation system 200 selectively allocates resource units 242, 244 based on a speed of the station 10. In particular, when the station 10 is moving relative to the access point 20, the mobility of a station 10 creates additional carrier frequency offset (CFO) that degrades the network connection. As such, the access point 20 may receive a request for resources 202 for the station 10 and, based on a status of the station 10 (i.e., stationary, moving at a speed lower than a threshold speed, or moving at a speed exceeding the threshold speed), allocate either resource units 242 or ultra-robust resource units 244. As described in greater detail below with respect to FIGS. 2 and 3, the ultra-robust resource units 244 include a greater number of pilot subcarriers 320 (also referred to as pilot tones 320) than resource units 242 of the same size to better counteract the additional CFO introduced when the station 10 is moving relative to the access point 20 at a speed exceeding a threshold speed.

The station 10 may communicate with the access point 20 via the network 40 that includes wireless connections using Wireless Fidelity (Wi-Fi) (a generation of 802.11), or any other wireless standards. The access point 20 is configured to wirelessly communicate with the station 10 via the network 40 and includes data processing hardware 22 and memory hardware 24 storing instructions that when executed on the data processing hardware 22 cause the data processing hardware 22 to perform operations. In addition to the Wi-Fi network 40 shown in FIG. 1, the access point 20 may directly use a satellite connection, cellular connection, and/or Ethernet over Coax or fiber networks. The station 10 can be any computing device that is capable of wireless communication with the access point 20. While the station 10 includes a vehicle in the example shown, the station 10 may also include any user device located within and/or in communication with the vehicle (e.g., a mobile device that is brought on board a moving environment), without limitation, a smart phone, a smart watch, a laptop, a desktop, or a smart display. The vehicle 10 may also be a light-duty or heavy-duty car or truck, a bus, a train, or any transportation device equipped with a communication system and capable of sending and/or receiving data over Wi-Fi. The station 10 includes data processing hardware 12 and memory hardware 14 storing instructions that when executed on the data processing hardware 12 cause the data processing hardware 14 to perform operations. The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the resource allocation system 200 is shared across the access point 20, the station 10, and/or the remote system 60. The remote system 60 may be used for internet access, private network access, client authorization, client authentication, and/or accounting. Optionally, the remote system 60 is connected with the access point 20 that connects to the station 10 via the Wi-Fi network 40.

With reference to FIGS. 1 and 2, the resource allocation system 200 includes an identifier module 210, a classifier 220, an allocator module 230, and a resource units data store 240. The identifier module 210 is configured to receive the request for resources 202 and determine, based on the request for resources 202, a status 212 of the station 10 that submitted the request for resources 202. For example, the station 10 may be stationary (i.e., parked or not moving) or moving relative to the access point 20. When the station 10 is moving relative to the access point 20 at a speed that exceeds a threshold speed (e.g., 3 kilometers/hour, 5 kilometers/hour, etc.,), the identifier module 210 may determine that the station 10 is a mobile station 10M and output a status 212 indicating that the station 10 is a mobile station 10M. Conversely, when the station 10 is stationary, or is moving at a speed that does not exceed the threshold speed, the identifier module 210 determines that the station 10 is not mobile and outputs a status 212 indicating that the station 10 is not mobile.

In some implementations, the request for resources 202 includes at least one of a station identifier 204 or a station speed 206. For example, the station identifier 204 may include a unique identity, such as the type of the station 10 that indicates to the identifier module 210 that the station 10 is a mobile station 10M. The station speed 206 may include an instantaneous speed (e.g., one or both of a magnitude and direction) of the station 10, an acceleration profile of the station 10, and/or the yaw rate of the station 10. In some implementations, the access point 20 (e.g., via the identifier module 210) receives the station identifier 204 and/or the station speed 206 separately from the request for resources 202. In these implementations, the access point 20 may receive the station identifier and/or the station speed 206 when the station 10 connects to the access point 20, for example during the Wi-Fi association process. In some implementations, the access point 20 receives the request for resources 202, the station speed 206, and the station identifier 204 all in different time instances. Here, the station identifier 204 may be received during the association process. The station speed 206 may be received at the access point 20 periodically based on an agreement between the access point 20 and the station 10. The request for resources 202 may be received by the access point 20 after the Wi-Fi association process is complete, and when the data arrives at the access point 20 to be transmitted to the station 10 via downlink or when the station 10 has data to transmit to the access point 20 via trigger-based uplink.

With continued reference to FIG. 2, the classifier 220 is configured to receive the request for resources 202 and process the request for resources 202 to determine whether the request for resources 202 includes a request type 222 for a trigger-based uplink or a downlink between the station 10 and the access point 20. Thereafter, the classifier 220 generates, as output, the request type 222. Based on the request type 222 (i.e., trigger-based uplink or downlink), the request for resources, and the status 212 of the station 10, the access point 20 may modify one or more attributes to receive or send the resources units 242, 244. For example, when the request for resources 202 is a trigger-based uplink, the access point 20 may tune its timing, frequency, and power levels to receive the trigger-based uplink of the resource units 242, 244 in addition to allocating resource units 242, 244 based on the speed of the station 10 relative to the station 20.

The allocator module 230 is configured to receive the request for resources 202, the status 212 of the station 10 output by the identifier module 210, and the request type 222 output by the classifier 220, and allocate resource units 422, 424 based on the request for resources, the status 212 of the station 10, and the request type 222 of the request for resources 202. In particular, the allocator module 230 has access to a resource units data store 240 that records/stores the resource units 240 available to the access point 20 for allocation to one or more stations 10. The records on the resource units data store 240 may be stored on any of the memory hardware 14, 24, 64 and include one or more resource units 242, 242a-n and one or more ultra-robust resource units 244, 244a-n. In some implementations, the ultra-robust resource units 244 are distributed resource units 244. When the allocator module 230 receives the status 212 of the station 10 indicating that the station 10 is a mobile station 10M, the allocator module 230 may allocate one or more ultra-robust resource units 244 from the resource units data store 240 to the mobile station 10M. Conversely, when the allocator module 230 receives the status 212 of the station 10 indicating that the station 10 is not mobile, the allocator module 230 may allocate the resource units 242 from the resource units data store 240 to the mobile station 10.

Referring to FIGS. 3A-3C, the resource units 244 and the ultra-robust resource units 242 each include a plurality of subcarriers 310 configured for data transmission. One or more of the subcarriers 310 includes pilot subcarriers 320 configured to provide phase information and parameter tracking. Each resource unit 242, 244 further includes an inter-subcarrier spacing 330 that defines the distance between adjacent subcarriers 310 in the resource unit 242, 244. In some implementations, the ultra-robust resource units 242 include multiple configurations in a finite pre-defined set from which the resource allocator 230 can select. In particular, the number of pilot subcarriers 320 and/or the inter-subcarrier spacing 330 of the ultra-robust resource units 242 may be selected by the resource allocator 230 when the resource allocator 230 allocates the ultra-robust resource units 242 to the mobile station 10M.

With particular reference to FIG. 3A, which shows an example according to the system and method described in reference to FIG. 2, a resource unit 242 is shown with 22 (twenty-two) subcarriers 310, and four (4) pilot subcarriers 320, where each subcarrier 310 has an inter-subcarrier spacing 330, 330a that is relatively close together. As shown in FIG. 3B, and in contrast to the resource unit 242 of FIG. 3A, the ultra-robust resource unit 244a includes a greater number of pilot subcarriers 320 than the resource unit 242 of FIG. 3A. In particular, while the ultra-robust resource unit 244a has the same number of subcarriers 310 (i.e., 22 subcarriers 310) and the same inter-subcarrier spacing 330a, the ultra-robust resource unit 244a includes eight (8) pilot subcarriers 320 as compared to the four (4) pilot subcarriers 320 in the resource unit 242 of FIG. 3A. Referring now to FIG. 3C, the ultra-robust resource unit 244b may have more pilot subcarriers 320 (i.e., five (5) subcarriers 320) than the number of pilot subcarriers 320 (i.e., four (4) subcarriers 320) in the resource unit 242 shown in FIG. 3A, but less pilot subcarriers 320 (i.e., five (5) subcarriers 320) than the number of pilot subcarriers 320 (i.e., eight (8) subcarriers 320) in the ultra-robust resource unit 244a shown in FIG. 3B. Here, however, the ultra-robust unit 244B includes an inter-subcarrier spacing 330, 330b that is greater than the inter-subcarrier spacing 330a shown in the resource unit 242 of FIG. 3A and the ultra-robust resource unit 244a of FIG. 3B.

Referring again to FIGS. 2-3C, the resource allocator 230 (i.e., the access point 20) may select the number of pilot subcarriers 320 of each of the ultra-robust resource units 242 based on one or more characteristics of the mobile station 10M. For example, the resource allocator 230 may select an ultra-robust resource unit 244 with a number of pilot subcarriers 320 that is based on the speed of the mobile station 10M, where the higher the speed of the mobile station 10M, the greater number of pilot subcarriers 320 that are selected for the ultra-robust resource unit 244 allocated to the mobile station 10M. Additionally or alternatively, the resource allocator 230 may select an ultra-robust resource unit 244 with a high number of pilot subcarriers when the acceleration of the mobile station 10M indicates the speed of the mobile station 10M is varying, thereby creating an unstable connection between the mobile station 10M and the access point 20.

In implementations where the ultra-robust resource units 244 are distributed ultra-robust resource units 244, the resource allocator 230 may select/configure the inter-subcarrier spacing 330 of the distributed ultra-robust resource units 242. That is, the subcarriers 310 are not contiguously allocated such that consecutive subcarriers 310 within one resource unit 242, 244 may include a greater-than-one multiple of the resource unit 242, 244 inter-subcarrier spacing 330 (i.e., the smallest inter-distance between any two subcarriers 310 in the system such as resource unit 242, ultra-robust resource unit 244, whether distributed or contiguous). For example, the resource allocator 230 may additionally receive station context 208 including any known transmissions that would cause interference with the resource units 242, 244 that may be in the station 10 and/or in the environment surrounding the station 10. For example, the station context 208 may indicate potential interference with a Bluetooth® connection event (using e.g., 1 or 2 MHz channels). Here, the resource allocator 230 may select an ultra-robust resource unit 244 with a greater inter-subcarrier spacing 330 (e.g., the inter-subcarrier spacing 330 of FIG. 3C) to avoid interference with the Bluetooth channel. Put another way, the resource allocator 230 may select the inter-subcarrier spacing 330 of each of the ultra-robust resource units 244 based on determining a concurrent and interfering connection is operating in the same band and using frequency channels of a first size, where the inter-subcarrier spacing 330 of the ultra-robust resource unit 244 is selected to be of a second size that is greater than the first size. For example, the resource allocator 230 may allocate distributed Resource Units (e.g., distributed resource units 242, 244) such that consecutive subcarriers allocated to the distributed Resource Unit are 2.1 MHz apart, to ensure that the interference from concurrent Bluetooth connection events affect one subcarrier 310 of the allocated distributed Resource Unit 242, 244 at one time instance. Additionally or alternatively, the resource allocator 230 may select an ultra-robust distributed resource unit 244 with a greater inter-subcarrier spacing 300 based on a high speed of the mobile station 10M to cope with the high CFO caused by the high speed of mobile station 10M.

In some implementations, where the resource allocator 230 selects distributed Resource Units 224, 244, there may be one set of shared pilot subcarriers 320 for all sizes of the distributed Resource Units 242, 244. Here, a single set of pilot subcarriers 320 may sample the entire frequency band based on the mobility of the station 10. For example, in non-mobile stations 10, the resource allocator 230 may allocate the distributed Resource Units 242 such that once every M>1 pilot subcarrier 320 of a superset of possible pilot subcarriers 320 are included in the distributed Resource Unit 242 as a pilot subcarrier 320. Alternatively, in mobile stations 10M, the resource allocator 230 allocates ultra-robust distributed Resource Units 244 such that once every K pilot subcarriers 320 (where K=1, 2, 3, . . . <M) from a superset of pilot subcarriers 320 are included in the ultra-robust distributed Resource Unit 244 as a pilot subcarrier 320.

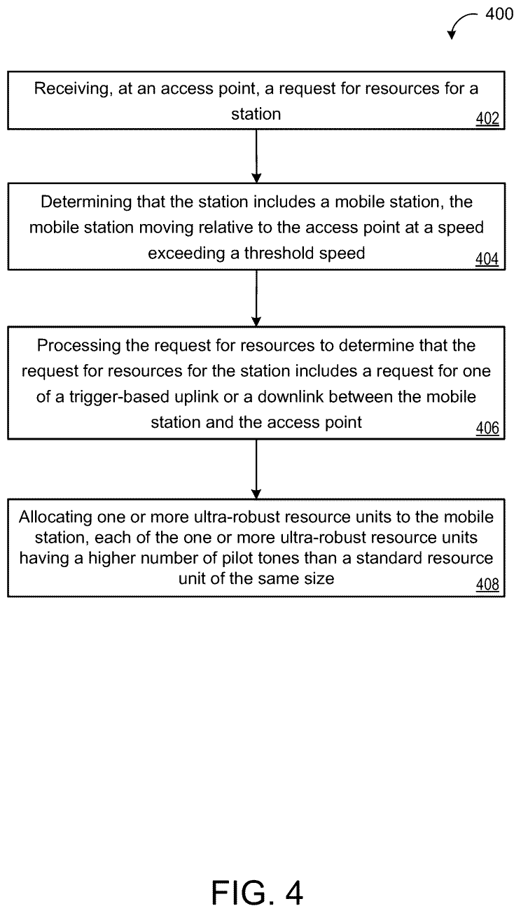

FIG. 4 includes a flowchart of an example arrangement of operations for a method 400 of physical resource allocation for mobile Wi-Fi stations 10. The method 400 may be described with reference to FIGS. 1-3C. Data processing hardware (e.g., data processing hardware 12, 22, 62 of FIG. 1) may execute instructions stored on memory hardware (e.g., memory hardware 12, 24, 64 of FIG. 1) to perform the example arrangement of operations for the method 400. At operation 402, the method 400 includes receiving, at an access point 20, a request for resources 202 for a station 10. At operation 404, the method 400 also includes determining that the station 10 includes a mobile station 10M, the mobile station 10M moving relative to the access point 20 at a speed exceeding a threshold speed.

At operation 406, the method 400 also includes processing the request for resources 202 for the station 10 to determine that the request for resources 202 includes a request for one of a trigger-based uplink or a downlink between the mobile station 10B and the access point 20. The method 400 further includes, at operation 408, allocating one or more ultra-robust resource units 244 to the mobile station 10B. Here, each of the one or more ultra-robust resource units 244 has a higher number of pilot tones 320 than a standard resource unit 242 of the same size.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving, at an access point, a request for resources for a station;
determining that the station includes a mobile station, the mobile station moving relative to the access point at a speed exceeding a threshold speed;
processing the request for resources for the station to determine that the request for resources includes a request for one of a trigger-based uplink or a downlink between the mobile station and the access point; and
allocating one or more ultra-robust resource units to the mobile station, each of the one or more ultra-robust resource units having a higher number of pilot tones than a standard resource unit of the same size.

2. The method of claim 1, wherein the one or more ultra-robust resource units includes a distributed resource unit.

3. The method of claim 1, wherein the number of pilot tones of each of the one or more ultra-robust resource units is selectable from a finite pre-defined set.

4. The method of claim 3, wherein the operations further comprise selecting the number of pilot tones of each of the ultra-robust resource units based on the speed of the mobile station.

5. The method of claim 1, wherein each of the one or more ultra-robust resource units comprises a selectable inter-subcarrier spacing from a finite pre-defined set.

6. The method of claim 5, wherein the operations further comprise selecting the inter-subcarrier spacing of each of the ultra-robust resource units based on the speed of the mobile station.

7. The method of claim 1, wherein allocating the one or more ultra-robust resource units to the mobile station comprises allocating the number of the one or more ultra-robust resource units based on the speed of the mobile station.

8. The method of claim 1, wherein the request for resources comprises one of an instantaneous speed of the station or an identifier of the station, and determining that the station includes the mobile station is based on the one of the instantaneous speed of the station or the identifier of the station.

9. The method of claim 1, wherein allocating the one or more ultra-robust resource units comprises:
determining a concurrent and interfering connection operating in a band and frequency channels of a first size; and
selecting an inter-subcarrier spacing of each of the one or more ultra-robust resource units having a second size greater than the first size.

10. The method of claim 1, wherein the mobile station is a vehicle.

11. A system comprising:
data processing hardware; and
memory hardware in communication with the data processing hardware, the memory hardware storing instructions that when executed on the data processing hardware cause the data processing hardware to perform operations comprising:
receiving, at an access point, a request for resources for a station;
determining that the station includes a mobile station, the mobile station moving relative to the access point at a speed exceeding a threshold speed;
processing the request for resources for the station to determine that the request for resources includes a request for one of a trigger-based uplink or a downlink between the mobile station and the access point; and
allocating one or more ultra-robust resource units to the mobile station, each of the one or more ultra-robust resource units having a higher number of pilot tones than a standard resource unit of the same size.

12. The system of claim 11, wherein the one or more ultra-robust resource units includes a distributed resource unit.

13. The system of claim 11, wherein the number of pilot tones of each of the one or more ultra-robust resource units is selectable.

14. The system of claim 13, wherein the operations further comprise selecting the number of pilot tones of each of the ultra-robust resource units based on the speed of the mobile station.

15. The system of claim 11, wherein each of the one or more ultra-robust resource units comprises a selectable inter-subcarrier spacing.

16. The system of claim 15, wherein the operations further comprise selecting the inter-subcarrier spacing of each of the ultra-robust resource units based on the speed of the mobile station.

17. The system of claim 11, wherein allocating the one or more ultra-robust resource units to the mobile station comprises allocating a number of the one or more ultra-robust resource units based on the speed of the mobile station.

18. The system of claim 11, wherein the request for resources comprises one of an instantaneous speed of the station or an identifier of the station, and determining that the station includes the mobile station is based on the one of the instantaneous speed of the station or the identifier of the station.

19. The system of claim 11, wherein allocating the one or more ultra-robust resource units comprises:
determining a concurrent and interfering connection operating in a band and frequency channels of a first size; and
selecting an inter-subcarrier spacing of each of the one or more ultra-robust resource units having a second size greater than the first size.

20. The system of claim 11, wherein the mobile station is a vehicle.
